(19) United States
(12) Patent Application Publication
(10) Pub. No.: US 2017/0187894 A1
(43) Pub. Date: Jun. 29, 2017

(54) SYSTEM AND METHOD FOR PRINT JOB FORWARDING

(71) Applicants: Kabushiki Kaisha Toshiba, Minato-ku (JP); Toshiba TEC Kabushiki Kaisha, Shinagawa-ku (JP)

(72) Inventors: Jia Zhang, Irvine, CA (US); Michael L. Yeung, Mission Viejo, CA (US); William Su, Riverside, CA (US)

(21) Appl. No.: 14/981,328

(22) Filed: Dec. 28, 2015

(51) Int. Cl. H04N 1/00; G06F 3/12

(52) U.S. Cl. CPC H04N 1/00204; H04N 1/0044; G06F 3/1205; G06F 3/1226; G06F 3/1261; H04N 2201/0094

(57) ABSTRACT

A document processing system includes a printer for printing user documents. When the printer is unable to perform a print job in accordance with the print requirements of a user's document, the document processing system queries the network for suitable alternative printers that are displayed to the user. The user selects an alternative printer to perform the print job and the print job is forwarded to the alternative printer for processing.

### TECHNICAL FIELD

Example embodiments of this application relates generally to providing a user with alternative print options when the user's selected printer is unable to perform the current print job in accordance with the print job requirements. The application has particular utility in connection with forwarding a print job to an alternative printer based on printer status and the print job requirements.

### BACKGROUND

Document processing devices are in widespread use in many businesses and academic settings. Such devices include copiers, scanners, printers and facsimile machines. Today, one or more functions associated with such devices are combined in a single unit, referred to as a multifunction peripheral (“MFP”) or multifunction device (“MFD”). MFPs are typically network connected to allow users to print remotely from their computers, scan documents that can be sent to a user's computer or a third party's computer (for example via email), copy documents, or fax documents to other people.

Paper jams, low toner conditions, or other fault conditions occasionally can occur on MFPs. When an MFP is experiencing one of these conditions, a user typically will not be aware of the condition on a particular MFP until after the user has scheduled a print job to the MFP. For example, if an MFP is low on toner, the user may not know of that problem until the user attempts to retrieve the scheduled print job from the MFP. Alternatively, the user may become aware that the MFP is unable to perform for the user's current print job only once the user is alerted by a low toner message on the MFP, or after the print job has been scheduled and a message pops up on the user's computer. At this point, the user will have to cancel the print job, find another suitable MFP, and resubmit the print job. In some instances, the MFP may have already printed the user's print job before the user is aware of the low toner condition. In this case, the print result may not meet the user's requirements, requiring the user to reprint the print job, for example on a different MFP, which is wasteful of toner and paper resources and may incur printing costs to the company. Also, requiring a user to return to their desk to resubmit the print job to a different MFP, after determining that the scheduled print job did not print, wastes the user's time and negatively impacts the overall user experience.

### SUMMARY

In accordance with an example embodiment of the subject application, a document processing device comprising an embedded controller and a display in communication with the embedded controller includes a processor that is configured to receive, via a network interface, a user requested document processing function associated with a document that is to be performed in accordance with document requirements, for example printing the document on the document processing device in accordance with selected paper size, selected paper, color or black or white printing, etc. The processor is further configured to query for an alternative document processing device that is capable of completing the requested document processing function for the document in accordance with some or all of the document properties. The processing generates a selectable list of alternative document processing devices, receives a selection from the selectable list, and forwards the requested document processing function or the document to the selected device. In an embodiment, the processor generates an indication that the document processing device is unable to complete the user requested document processing function in accordance with one or more of the document requirements. The indication can be a message communicated to the computing device of the user or a message that is presented on the display of the document processing device. The document processing device can include a user interface configured to accept a user selection of an alternative document processing device from a list of alternative document processing devices displayed on the display of the document processing device. The processor can be further configured to receive the document, determine a current printing capability based on the status of the document processing device, and generate a preview image of the printed document that would result if the document were printed based on the current printing capability of the document processing device. The preview image can be displayed on the display of the document processing device or sent to the user's computer.

In accordance with another example embodiment, a method includes receiving a user requested document processing function associated with a document that is to be performed in accordance with the document requirements, for example printing a document in accordance with selected paper size, selected paper, color or black or white printing, etc. The method include querying for an alternative document processing device capable of completing the requested document processing function for the document in according with one or more of the document requirements. The method includes presenting to the user a selectable list of alternative devices for completing the requested document processing function, receiving a selection from the selectable list, and forwarding the document or the requested document processing function to the selected device. The method can further include performing the requested document processing function in accordance with the document requirements. The method can also include generating an indication that the document processing device is unable to perform the requested document processing function in accordance with one or more of the document requirements. The method can include sending, to a user, an indication that the document processing device is unable to complete the requested document processing function in accordance with one or more of the document requirements. The indication can be a message sent to the user's computing device, a message displayed on the document processing device, or a printout of the document that is not in accordance with the document requirements, for example a printout that was not printed correctly.

In accordance with another example embodiment, a document processing system can include a printer configured to print documents in accordance with one or more document printing requirements, a network interface configured to receive a document to be printed, and a processor configured to determine a status of the printer and query the network for alternative printers when the printer is unable to print the received document in accordance with the document printing requirements. The system further includes a display configured to display alternative printers and a user interface to accept a selection of an alternative printer. The processor is further configured to send the document to the selected printer. The processor can be further configured to generate an indication that the printer is unable to print the document in accordance with the document requirements. The indication can be a message communicated to the user's computing device via the network interface or a message displayed on the document processing device. The processor can be further configured to generate a preview image of the how the document would be printed by the printer based on the current status of the printer. The display can be further configured to display the preview image, and the user interface can be further configured to accept a user command to print the image using the printer. The network interface can be further configured to send the preview image to the user's computing device. The network interface can be further configured to accept a user command to print the document using the printer. The network interface can be further configured to send a list of alternative printers to the user's computer and receive a selection of an alternative printer to print the document. The display can be further configured to display a list of print jobs associated with the user, the user interface can be further configured to accept a selection of one of the print jobs, and the processor can be further configured to send the document associated with the print job to the selected printer via the network interface.

### BRIEF DESCRIPTION OF THE DRAWINGS

Various embodiments will become better understood with regard to the following description, appended claims and accompanying drawings wherein:

FIG. 1 illustrates an example embodiment of a network;

FIG. 2 is a block diagram of an example embodiment of a document processing device;

FIG. 3 is a block diagram of an example embodiment of a document processing device functionality;

FIG. 4 is a functional block diagram of primary and alternative document processing devices;

FIG. 5 is a flowchart of example operations of a first embodiment of a document processing device with print job forwarding capability;

FIG. 6 is flowchart of example operations of a second embodiment of a document processing device with print job forwarding capability;

FIGS. 7 and 8 are example user interface screens for selecting alternative printers for print job forwarding.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Document processing devices are employed by users for multiple tasks, including the printing of documents. Suitable document processing devices include scanners, copiers, printers, plotters and fax machines. More recently, two or more of these functions are contained in a single device or unit, referred to as a multifunction peripheral (MFP) or multifunction device (MFD), which may also serve as an e-mail or other information routing gateway. As used herein, MFP includes any device having one or more document processing functions such as those noted above. While example embodiments described herein refer to MFPs, it will be appreciated that they may be also applied to single use devices, such as a printer.

MFPs can be expensive, particularly when multiple devices are required for service. In addition to unit costs, MFPs may consume resources, such as paper, toner, ink or power. It is therefore advantageous to share one or more MFPs among multiple users, via workstations, notebook computers, tablets, smartphones, or any other suitable computing device. Interaction between users and MFPs, between MFPs and servers, or between computing devices, can occur over any wired or wireless data infrastructure, such as local area networks (LANs), wide area networks (WANs) such enterprise WANS or the Internet, or point-to-point communication paths, such as universal serial bus (USB), infrared, Bluetooth, or near field communication (NFC).

A document processing system with print job forwarding features can leverage networked printing resources and allow a user to forward a print job to another MFP in the event there are problems with the selected MFP. The present disclosure allows a user to manually or automatically forward a print job to a suitable alternative MFP if there is a problem printing to the selected MFP.

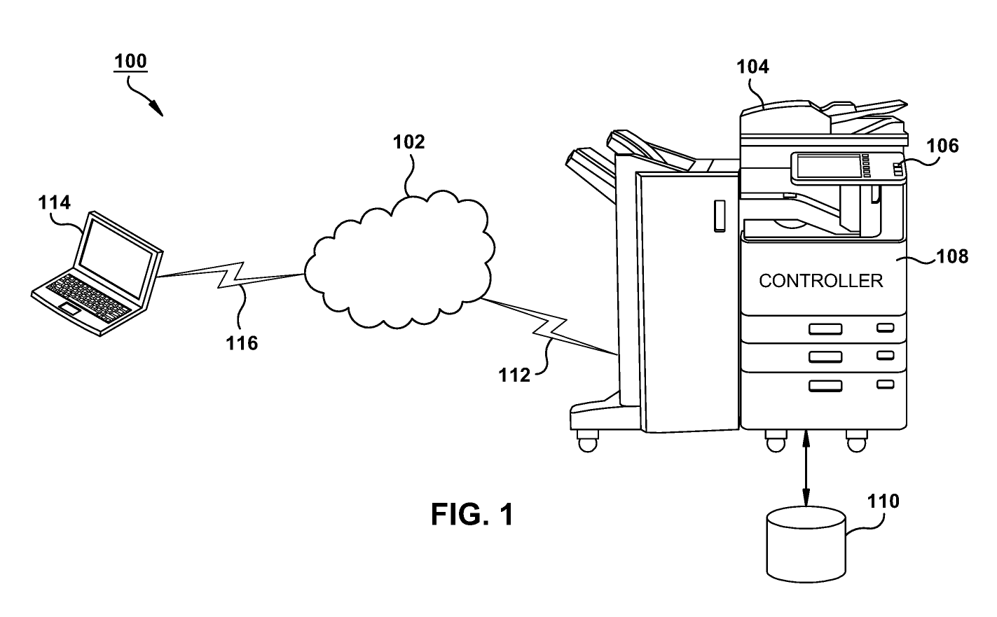

Turning now to FIG. 1, a document processing system 100 is presented. The document processing system 100 includes a network 102 that is in data communication with one or more document processing devices, suitably comprised of an MFP 104 as illustrated. In the example embodiment of FIG. 1, MFP 104 is coupled for data communication 112 with network 102, suitably comprised of a local area network (LAN), a remote local area network (RLAN), a wide area network (WAN) which may comprise the Internet, or any combination thereof. MFP 104 is suitably operable for printing, faxing, scanning, copying, e-mailing, or any other document processing operation will be understood by one of ordinary skill in the art. In the illustrated embodiment, MFP 104 includes a user interface 106. Operation of the MFP 104 is suitably managed by an embedded controller 108 and embedded data storage 110 as will be detailed further below. User interaction is suitably provided locally or remotely with any suitable computing devices 114, such as computers, tablets, PDAs, smartphones, or the like.

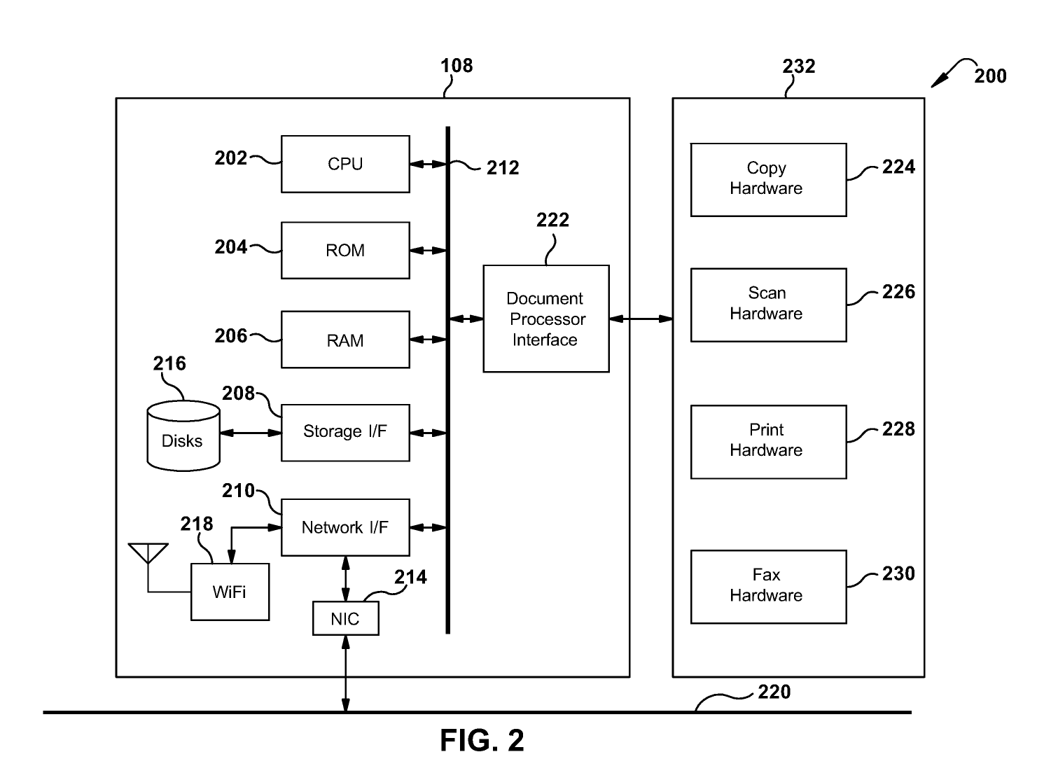

Turning now to FIG. 2, presented are functional components 200 suitably comprising a multifunctional peripheral such as MFP 104 of FIG. 1. Included is an example embodiment of controller 108 which is suitably comprised of a computer. Included in example controller 108 are one or more processors, such as illustrated by central processor unit (CPU) 202. Also included are non-volatile memory, such as read-only memory (ROM) 204, random access memory (RAM) 206, a storage interface 208, and a network interface 210. In the example embodiment, CPU 202, ROM 204, RAM 206, storage interface 208, and network interface 210, are in mutual data communication via bus 212. Storage interface 208 facilitates data access with bulk data storage, such as one or more disks 216, or any other suitable data storage such as a flash drive, solid state storage drive, CD, DVD or the like. Network interface 210 suitably provides for external data communication, such as with a network interface connection (NIC) 214 or WiFi interface 218. NIC 214 or WiFi interface 218 suitably provide for connection to an associated network 220. A document processor interface 222 is also in data communication with bus 212, and provides a gateway to copy hardware 224, scan hardware 226, print hardware 228 and fax hardware 230 which together comprise MFP functional hardware 232.

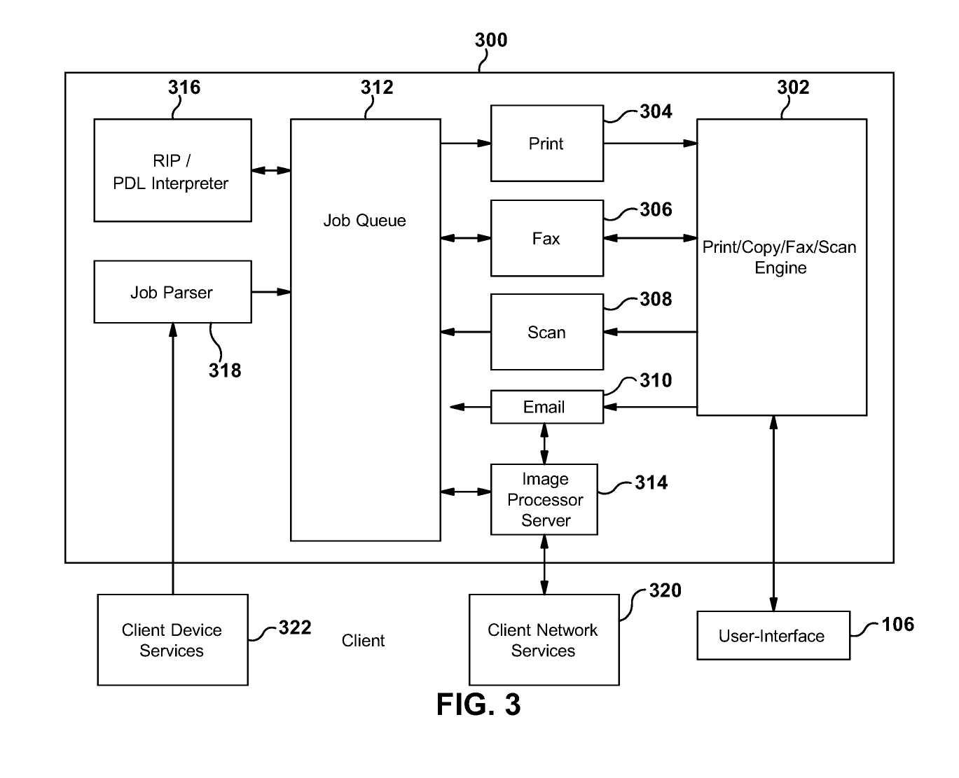

Turning now to FIG. 3, illustrated is a functional block diagram 300 of an example MFP. Included is a print/copy/fax/scan engine 302 which interfaces with print control 304, fax control 306, and scan control 308, all of which are suitably interfaced with job queue 312. Print/copy/fax/scan engine 302 is suitably interfaced with on-screen document manager 310. On-screen document manager 310 is in communication with image processing server 114 via network services 314. Print/copy/fax/scan engine 302 is suitably provided with user access via user interface 106. Job queue 312 is suitably interfaced with raster image processor (RIP) and page description language (PDL) functionality 316, as well as job parser 318. Job parser 318 is suitably interfaced with client device services 322. Job queue 312 is suitably interfaced with network services 314, which in turn is interfaced with client network services 320.

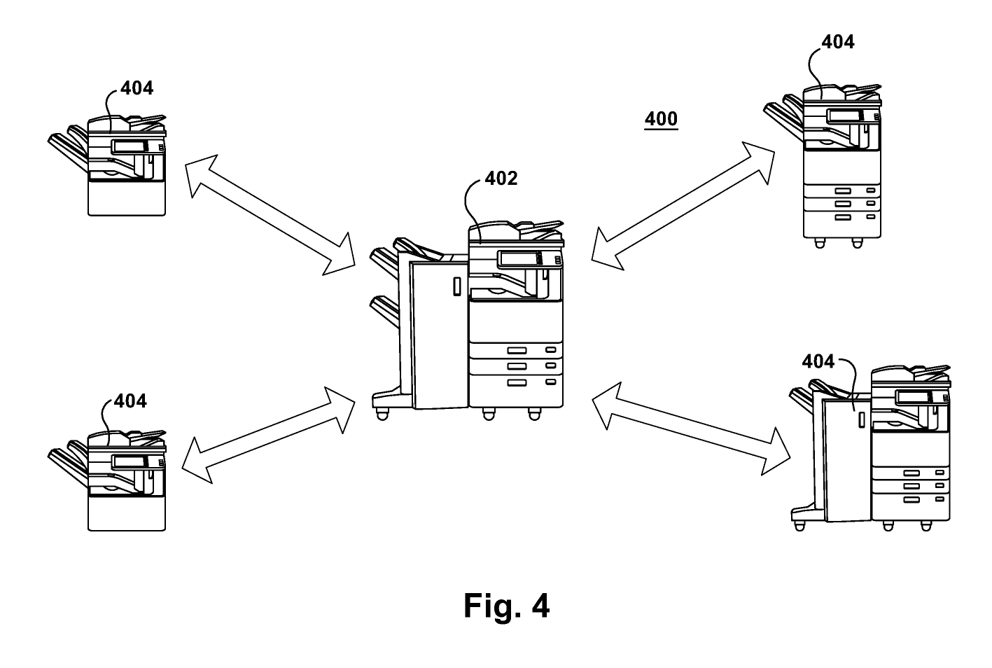

Turning now to FIG. 4, a functional diagram of a network 400 of primary and alternative document processing devices is presented. In the network 400, the primary MFP 402 is in communication with other MFPs 404 via network communications as described above. When the primary MFP 402 receives a print job, or a request for any suitable document processing function, the primary MFP 402 can send a suitable query to other MFPs 404 to determine if any other MFPs 404 could meet the received print job's printing requirements. This information can be shared locally via a user display interface, or the information can be sent to the user's computing device. For example, a user may be having difficulty with a particular print job at the primary MFP 402. For example, the primary MFP 402 may have a paper jam, be out of the desired type of paper, or be low on toner. The primary MFP 402 can query other MFPs 404 and provide the user with a list of other MFPs 404 that are capable of performing the user's print job, for example other MFPs 404 that might be nearby to the primary MFP 402. The list can include selection buttons enabling the user to manually direct the print job to one of the other MFPs 404 as will be discussed in greater detail below. In a configuration, the primary MFP 402 can direct the user's print job to one of the other MFPs 404 and inform the user of the change. This configuration may be desirable in situations where the primary MFP 402 and one of the other MFPs 404 are co-located or otherwise in proximity to one another.

Although the print job forwarding capability is ideally suited to print jobs, any suitable document processing function can be forwarded from the primary MFP 402 to one of the other MFPs 404 as would be understood in the art. For example, if a document is to be faxed by the primary MFP 402, but the primary MFP 402 is unable to perform the function, then that job can be forwarded to one of the other MFPs. In a configuration, the document can be separate from the document processing function. For example, a document to be printed can be stored on a separate server, while the document processing function that includes the instructions for performing the print job and retrieving the document can be send to the printer. Each document to be printed can include one or more document requirements such as the size of the paper, the type of paper to be printed on, whether the printing is to be performed in color, black and white, or greyscale, and so forth.

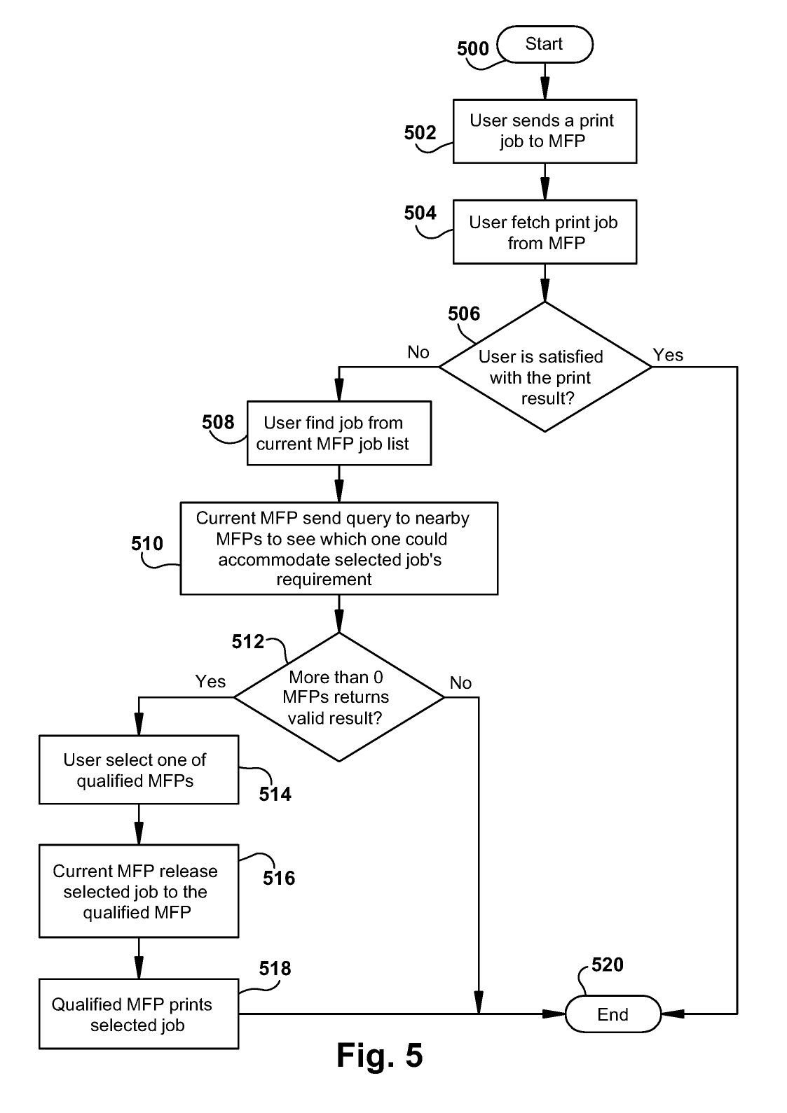

Referring now also to FIG. 5, an example flowchart of operations of a first embodiment of a document processing device with alternative printer selection capability is presented. Processing starts at process block 500 labeled “START” and continues to process block 502.

In process block 502, a user sends a print job, or a request for any suitable document processing function, to an MFP. Processing continues to process block 504.

In process block 504, the user fetches the print job from the MFP, for example by walking to the MFP from the user's desk in an attempt to obtain and review the print job. In some situations, the print job may have problems. For example, the printer may be out of paper, low on toner, or jammed. Or the print job itself may not meet the user's requirements, such as may occur if a color printer is low on a particular color of toner, or if the print job was not printed onto the desired paper type, such as letterhead or bonded paper instead of regular paper. Processing continues to decision block 506.

In decision block 506, if the user is satisfied with the print result, then processing terminates at end block 520 labeled, “END”. If the user is not satisfied with the print result, for example if the print job has not been performed or if the print job does not meeting the user's requirements, then processing continues to process block 508.

In process block 508, the user can query the MFP for recent jobs and select the desired print job from the list. The query can be limited to the user, for example using a password or other form of authentication as would be understood in the art. Processing continues to process block 510.

In process block 510, the current MFP can send a query to other MFPs in the network to determine which alternative MFPs can accommodate the requirements of the selected print job. In a configuration, only MFPs that meet the exact requirements are queried. In a different configuration, rules can be used to determine suitable MFPs. For example, if the user's requirements include color printing, but no suitable color printers are available, the query can be expanded to include MFPs that can only print in black and white. In another example, the query can prioritize suitable MFPs based on the requirements, but include other MFPs. For example, a local printer on the same floor can be prioritized over a similar printer that is further away or on another floor. Processing continues to decision block 512.

In decision block 512, if it is determined, as the result of the query of process block 510, that no suitable MFPs are available, then processing terminates at end block 520. Otherwise, processing continues to process block 514.

In process block 514, the user can look through the list, or display, of alternative MFPs that are available to process the user's print job. The user selects a desired alternative MFP to process the user's print job. Processing continues to process block 516.

In process block 516, the current MFP releases the selected job to the alternative MFP selected by the user. In a configuration, the user can be required to confirm the release of the selected job to the alternative MFP. Processing continues to process block 518.

In process block 518, the alternative MFP selected by the user in process block 514 receives the selected job from process block 516 and prints the print job. Processing terminates at end block 520.

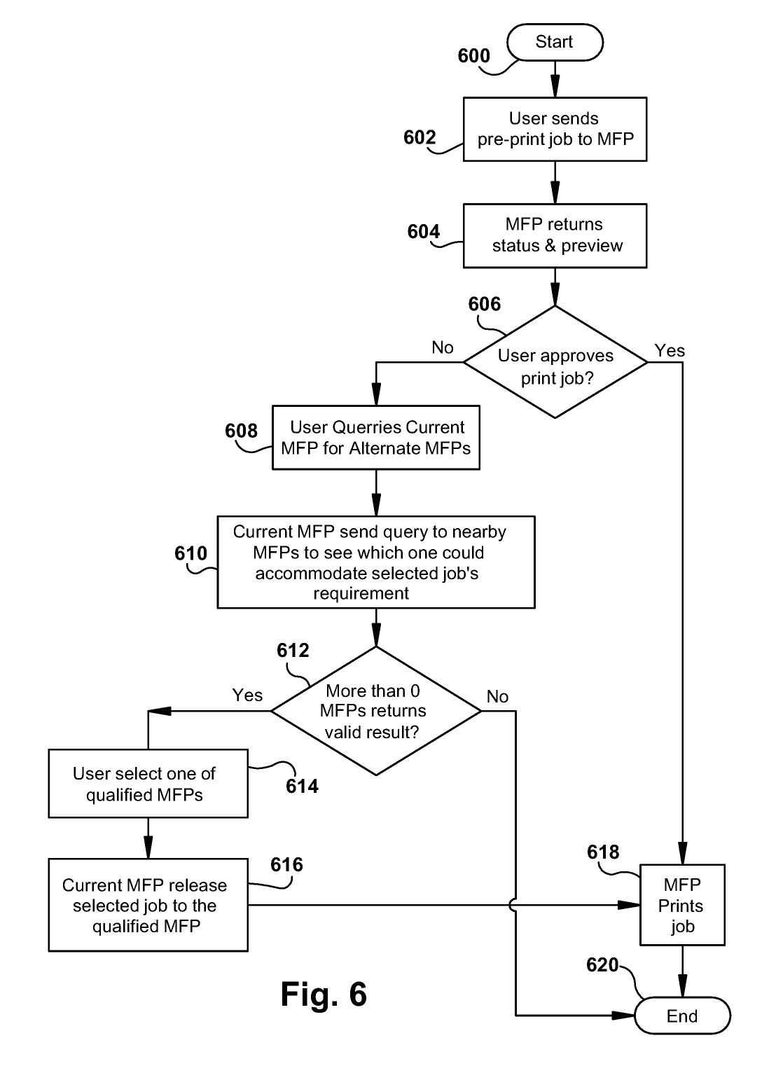

Referring now to FIG. 6, an example flowchart of operations of a second embodiment of a document processing device with alternative printer selection capability is presented. Processing starts at process block 600 labeled “START” and continues to process block 602.

In process block 602, a user sends a pre-request for a print job, or a pre-request for any suitable document processing function, to an MFP. In a configuration, a pre-request can include sending the print job to the MFP with a request for the MFP to determine whether the MFP can process the print job given the user's print job requirements. In a configuration, the pre-request can include querying the MFP's current status prior to sending the print job, or in addition to sending the print job. Processing continues to process block 604.

In process block 604, the MFP responds to the pre-request of process block 602. Based on the response from the MFP, the user can determine whether or not to release the print job to the MFP. In a configuration, the MFP can return the status of the MFP and the user can make a determination whether or not to continue sending the print job to the MFP. In a configuration, the MFP can generate a preview of the print job based on the received print job and the MFP's current condition. For example, if the MFP is low on red toner, the MFP can return a preview of the anticipated printout that would result if the MFP were to print the user's print job given the NIFPs low toner status. In another example, if the user requires legal paper and the MFP only has letter sized paper, then MFP can return a preview of the anticipated printout using letter paper. Processing continues to decision block 606.

In decision block 606, if the user is approves printing the print job on the MFP, then processing continues to process block 618. Otherwise, if the user does not approve printing the print job on the MFP, for example if the print job cannot been performed due to a service condition or if the MFP would not be able to meet all of the user's requirements, then processing continues to process block 608.

In process block 608, the user can query the MFP for alternative MFPs. Processing continues to process block 610.

In process block 610, the current MFP can send a query to other MFPs in the network to determine which alternative MFPs can accommodate the requirements of the selected print job. In a configuration, only MFPs that meet the exact requirements are queried. In a different configuration, rules can be used to determine suitable MFPs. For example, if the user's requirements include color printing, but no suitable color printers are available, the query can be expanded to include MFPs that can only print in black and white. In another example, the query can prioritize suitable MFPs based on the requirements, but include other MFPs. For example, a local printer on the same floor can be prioritized over a similar printer that is further away or on another floor. Processing continues to decision block 612.

In decision block 612, if it is determined, as the result of the query of process block 610, that no suitable MFPs are available, then processing terminates at end block 620, labeled “END”. Otherwise, processing continues to process block 614.

In process block 614, the user can look through the list, or display, of alternative MFPs that are available to process the user's print job. The user selects a desired alternative MFP to process the user's print job. Processing continues to process block 616.

In process block 616, the current MFP releases the selected job to the alternative MFP selected by the user. In a configuration, the user can be required to confirm the release of the selected job to the alternative MFP. Processing continues to process block 618.

In process block 618, the MFP selected by the user receives and prints the print job. Processing terminates at end block 620.

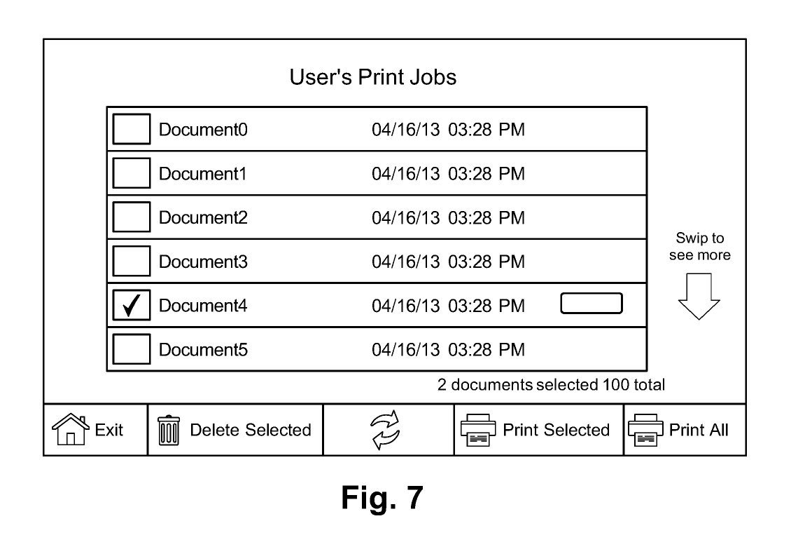

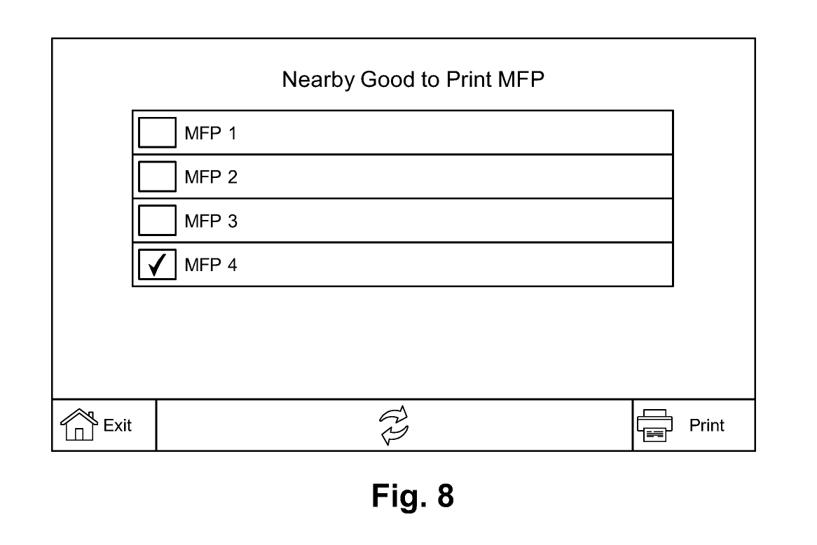

Referring now to FIGS. 7 and 8, example user interface screens for selecting alternative printers are presented. The user interface screen can be presented on the user interface of the MFP, or send to the user's computer, for example in a pop up window. FIG. 7 illustrates the user's recent print jobs on the MFP, and includes a selection button. FIG. 8 illustrates a list of alternative MFPs for printing the user's print job, and includes a selection button.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A document processing system, comprising:
a printer configured to print documents in accordance with one or more document printing requirements associated with each document;
a network interface configured to receive a document to be printed;
a processor configured to determine a current status of printing capabilities of the printer and, when the printer is unable to print the received document in accordance with one or more associated document printing requirements, query for one or more alternative printers via the network interface;
a display configured to display the one or more alternative printers;
a user interface configured to accept a selection of a selected printer from the one or more alternative printers,
wherein the processor is further configured to send the document to the selected printer via the network interface;
wherein the processor is further configured to generate a preview image of how the document would be printed by the printer based on the current printing capabilities of the printer.

2. The document processing system of claim 1, wherein the processor is further configured to generate an indication that the printer is unable to print the received document in accordance with at least one of a plurality of document requirements.

3. The document processing system of claim 2, wherein the indication is selected from a group consisting of a message communicated via the network interface to a computing device of a user associated with the document, and a message presented on the display of a document processing device.

4. The document processing system of claim 1, wherein the processor is further configured to determine the current printing capabilities of the printer in accordance with a current level of printer consumables.

5. The document processing system of claim 4, wherein the display is further configured to display the preview image, and wherein the user interface is further configured to accept a user command to print the image using the printer.

6. The document processing system of claim 4, wherein the network interface is further configured to send the preview image to a computing device of a user associated with the document.

7. The document processing system of claim 6, wherein the network interface is further configured to accept a user command to print the document using the printer.

8. The document processing system of claim 1, wherein the network interface is further configured to send a list of one or more alternative printers to the computing device of a user associated with the document, and receive a selection of a selected printer from the computing device of the user.

9. The document processing system of claim 1, wherein the display is further configured to display a list of print jobs associated with a user, and
wherein the user interface is further configured to accept a selection of one of the print jobs as the selected print job, and
wherein the processor is further configured to send the document associated with the selected print job to the selected printer via the network interface.

10. A method, comprising:
receiving, by a document processing device, a user requested document processing function associated with a document to be performed in accordance with a plurality of document requirements;
determining current printing capabilities of the document processing device;
generating a preview image of how the document processing function would be rendered based on the current printing capabilities of the document processing device;
querying, by the document processing device, for an alternative document processing device capable of completing the requested document processing function for the document in accordance with one or more of the plurality of document requirements;
presenting, to the user, a selectable list of one or more alternative document processing devices for completing the requested document processing function;
receiving, from the user, a selection of an alternative document processing device from the selectable list; and
forwarding, by the document processing device, one or more of the requested document processing function or the document to the alternative document processing device selected by the user.

11. The method of claim 10, further comprising:
performing, by the alternative document processing device, the requested document processing function for the document in accordance with one or more of the plurality of document requirements.

12. The method of claim 10, further comprising:
generating, by the document processing device, an indication that the document processing device is unable to complete the user requested document processing function in accordance with at least one of a plurality of document requirements.

13. The method of claim 10, further comprising:
sending, to a user, an indication that a document processing device is unable to complete the user requested document processing function associated with the document in accordance with at least one of a plurality of document requirements.

14. The method of claim 13, wherein the indication is selected from the group consisting of a message communicated from the document processing device to a computing device of the user, a message presented on a display of the document processing device, and a printout of a document that is not in accordance with the plurality of document requirements.

15. A document processing device, comprising:
an embedded controller including a processor, a memory in data communication with the processor, and a network interface in communication with the processor, the memory operable for storage of data and instructions, and the network interface configured for data communication via an associated network; and
a display in communication with the embedded controller;
wherein the processor is configured to
receive, via the network interface, a user requested document processing function associated with a document to be performed in accordance with a plurality of document requirements,
query, via the network interface, for an alternative document processing device capable of completing the requested document processing function for the document in accordance with one or more of the plurality of document requirements,
generate a selectable list of one or more alternative document processing devices for completing the requested document processing function,
receive a selection of an alternative document processing device from the selectable list,
forward, via the network interface, one or more of the requested document processing function or the document to the selected alternative document processing device,
receive the document,
determine a current printing capability of the document processing device,
generate a preview image of a printing of the document based upon the current printing capability of the document processing device, and
send the preview image to one or more of the display of the document processing device, or a computer that initiated the user requested document processing function.

16. The document processing device of claim 15, wherein the processor is further configured to generate an indication that the document processing device is unable to complete the user requested document processing function in accordance with at least one of a plurality of document requirements.

17. The document processing device of claim 16, wherein the indication is selected from the group consisting of a message communicated via the network interface to a computing device of the user, and a message presented on the display of the document processing device.

18. The document processing device of claim 15, further comprising a user interface, and
wherein the selectable list of one or more alternative document processing devices for completing the requested document processing function is presented on the display of the document processing device, and
wherein the selection of an alternative document processing device from the selectable list is received via the user interface of the document processing device.

19. The document processing device of claim 15, wherein the processor is further configured to
determine a current printing capability of the document processing device based on a current of level consumables in the document processing device;

20. The document processing device of claim 15, wherein the user requested document processing function includes printing the document in accordance with the plurality of document requirements.
